(19) United States
(12) Patent Application Publication
(10) Pub. No.: US 2008/0035436 A1
(43) Pub. Date: Feb. 14, 2008

(54) STRUCTURE OF A HAND-BRAKE

(76) Inventor: Ming-Huang Chiang, Shui Shang Hsiang (TW)

Correspondence Address: LEONG C LEI, PMB # 1008, 1867 YGNACIO VALLEY ROAD, WALNUT CREEK, CA, 94598, US

(21) Appl. No.: 11/457,463

(22) Filed: Jul. 14, 2006

(51) Int. Cl. F16D 65/14

(52) U.S. Cl. 188/2 D

(57) ABSTRACT

A hard-brake structure which includes a securing seat having a side edge provided with a plurality of teeth, a pulling shaft seat pivotally connected with the securing seat by a pivotal shaft, a pulling shaft having a pivotal section pivotally connected with the pulling shaft seat, a positioning toothed block pivotally connected with the pulling shall seat, a resilient member having a first end fixed on the pulling shaft seat and a second end bearing against the interlinking section of the positioning toothed block, an interlinking block fitted in the sliding slot and the hole and capable of moving in the sliding slot and the hole, a pulling block having a first end protruded out of the opening of the pulling shaft and a second end connected with a linking rod, and a spring mounted on the linking rod of the pulling block.

### BACKGROUND OF THE INVENTION

(a) Technical Field of the Invention

The present invention relates to an improvement in the structure of a hand brake, and in particular to one which is labor saving in operation.

(b) Description of the Prior Art

FIGS. 6 and 7 show the structure of a conventional hand brake which includes a pulling shaft 60 having a press button 61, a positioning teeth block 62 on the polling shaft 60 linked to the press button 61 so that the engaging teeth 63 at one end of the positioning teeth block 62 is disengaged from the positioning teeth slot 65 of the securing seat 64. Thus, the pulling shaft 60 can be pulled to swing through an appropriate angle to control the brake by means of the braking cable 66 on the pulling shad 60.

According to the conventional hand brake, one end of the braking cable 66 is acted upon by the restoration force of the elastic element, and so the braking cable 66 maintains at a tightened state and the pulling shall 60 swings downward when it is pulled by the braking cable 66. When the pulling shaft 60 is pulled to cause the brake to have a braking effect, a force which is greater than the restoration force of the elastic element is required and thus, the brake cable 66 is pulled upward to achieve the object. When the brake cable is pulled upward, the engaging teeth 63 at one end of the positioning teeth block 62 is engaged with the positioning teeth slot 65 on the positioning seat 64, and the pulling force 60 is positioned at a specific angle so as to maintain, at the braking state, as shown in FIG. 7.

When the pulling shaft 60 is polled upward to position so as to produce a braking effect, the deformation, of the elastic element of the brake increases, and the pulling force will increase greatly. Thus, when the engaging teeth 63 is engaged at the positioning teeth slot 65, the larger polling force of the brake cable 66 causes the engaging teeth 63 to produce a downward force to the positioning teeth 65. Thus, in order to press the press button 61 to cause the engaging teeth 63 to release from the teeth slot 65, a very large pressing force has to be applied, and by pressing wife a thumb is not easy. As a result, in applicants, the polling shaft 60 is pulled, up to an angle so that the engaging teeth 63 moves upward away from the positioning teeth slot 65 with an appropriate distance so that the engaging teeth 63 will not exert a force downward to the positioning teeth 65. Thus the press button 61 can be easily pressed to cause the teeth block 62 to swing to an angle so that, fee engaging teeth 63 is released, font the positioning teeth slot 65 50 that the pulling shaft 60 is continuously swing to an angle.

When the brake cable 66 is at a tightened state and if the cable 66 is to pull upward so that the engaging teeth 63 moves upward from the teeth slot 65 to an appropriate distance, a larger force is needed. Thus for the lady driver the pulling shaft 60 may not be pulled up easily and the brake is not operable. It is of course a danger if the brake fails in the course of uphill or downhill.

In view of the above, it is an object of the present invention to provide an improvement in the structure of a hand-brake which can mitigate and obviate the above drawbacks.

### SUMMARY OF THE INVENTION

It is the primary object of the present invention to provide a hand-brake structure which includes: a securing seat having a side edge provided with a plurality of teem; a pulling shaft seat pivotally connected with said securing seat by a pivotal shah and provided with a guiding slot in which is surrounded a braking cable, said braking cable having a first end fastened to an end section of said guiding slot and a second end connected to a braking device; a polling shaft having a pivotal section which is pivotally connected with said pulling shaft seat by a pivotal shaft, said pivotal section having a pushing section, said pulling shaft having a hole extending through said pulling shaft to form an opening; a positioning toothed block pivotally connected with said pulling shaft seat by a pivotal shaft, said positioning toothed block having a first end provided with a tooth engageable with said teeth of said securing seat and a second end provided with an interlinking section extending over said pushing section; a resilient member having a first end fixed on said pulling shaft seat and a second end bearing against said interlinking section of said positioning toothed block thereby forcing said tooth of said positioning toothed, block to engage with said teeth of said securing seat; an interlinking block fitted in said, sliding slot and said hole and capable of moving in said sliding slot and said, hole; a pulling block having a first end protruded out of said opening of said pulling shaft, and a second end connected with a linking rod which is connected with an end of said interlinking block; and a spring mounted on said linking rod of said polling block and having a first end urging against an end of said pulling block and a second end fastened to a wall of said hole, whereby the hand-brake is labor-saving in operation.

The foregoing object and summary provide only a brief introduction to the present invention. To fully appreciate these and other objects of the presort invention as well as the invention, itself, all of which will become apparent to those skilled in the art, the following detailed, description of the invention and the claims should be read in conjunction with the accompanying drawings. Throughout the specification and drawings identical reference numerals refer to identical or similar parts.

Many other advantages and features of the present invention will become manliest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded, view of the present invention.

FIG. 2 is a perspective view of the present invention.

FIG. 3 is a sectional view of the hand brake according to the present invention.

FIG. 4 is a schematic view showing the upward pulling of the brake cable according to the present invention.

FIG. 5 is a schematic view showing the pulling shad swinging according to the present invention.

FIG. 6 is a sectional view of a conventional hand-brake.

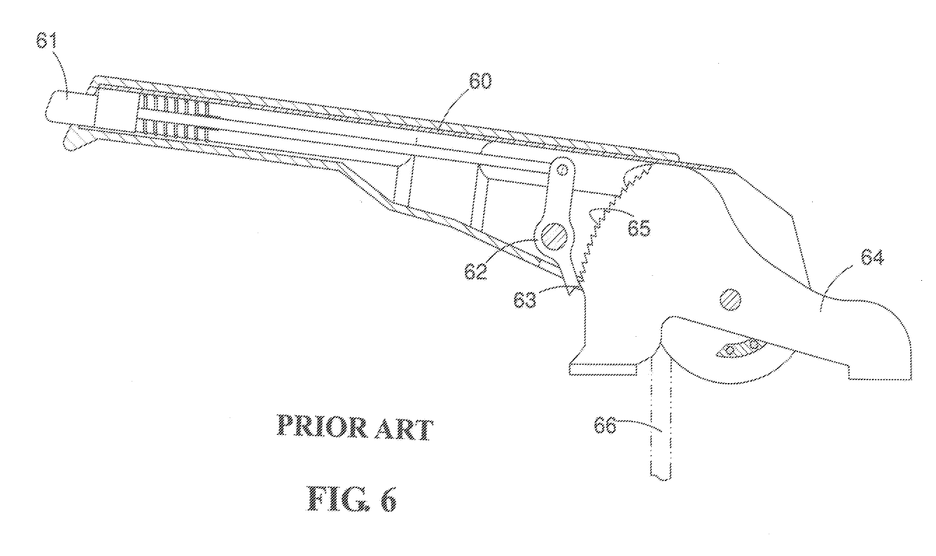

FIG. 7 is a schematic view showing the upward pulling of the conventional hand-brake.

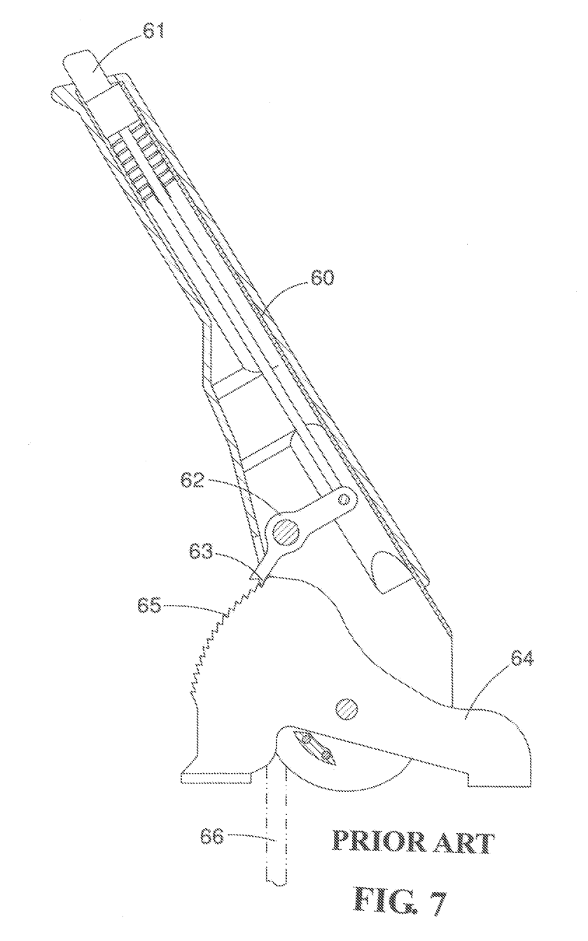

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function, and arrangement, of the elements described without departing from the scope of the invention as set forth in the appended claims.

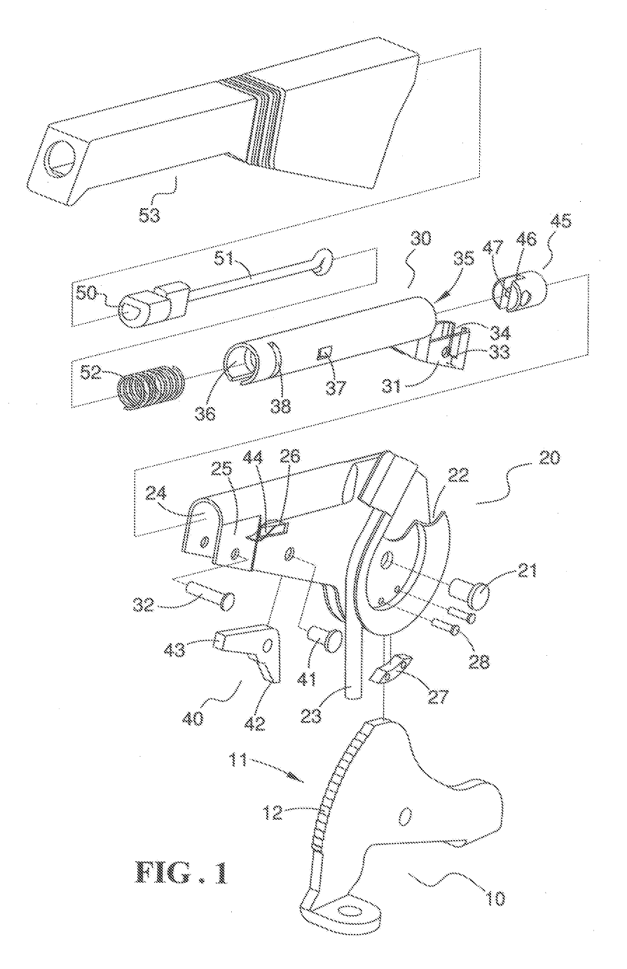

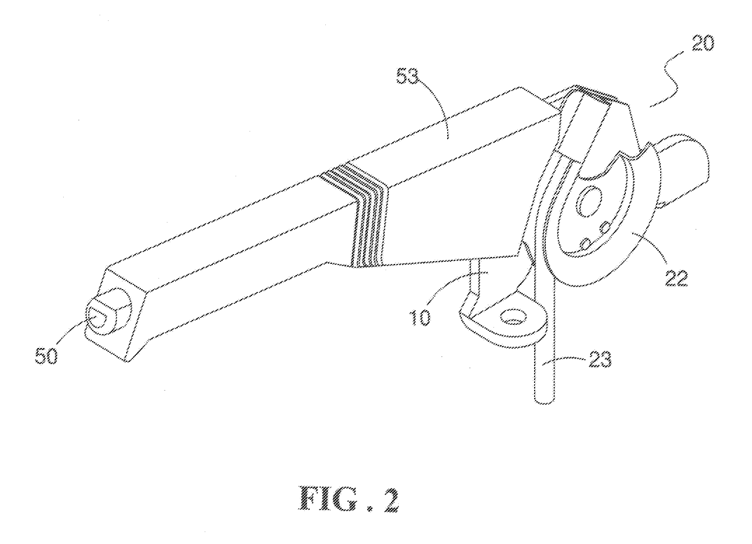

Referring to FIGS. 1 to 4, there is shown a hand-brake structure in accordance with the present invention.

The hand-brake structure mainly comprises a securing seat 10, a pulling shaft seat 20, a stopping block 27, a pulling shah 40, a positioning toothed block 30, a resilient member 44, an interlinking block 54, a press button 50, a spring 52 and a shaft housing 53.

The securing seat 10 has a side edge provided with a circular arch 11 having a plurality of teeth 12.

The pulling shaft seat 20 includes a shaft 21 pivotally mounted to the securing seat 10 and has a guiding slot 22 at one side. The guiding slot 22 is surrounded by a hand-brake cable 23 having one end fixed to the end section of the guiding slot 22, and the other end of the brake cable 23 connected to a braking device. The pulling shaft seat 20 has a sliding slot 24 and one end of the pulling shaft seat 20 is provided with an end seat section 25. A securing plate 26 is mounted within the polling shaft seat 20.

The stopping block 27 is fixedly mounted on the pulling shaft seat 20 by pins 28 for bearing against the securing seat 10 thereby limiting the swinging angle of the pulling shaft seat 20.

The pulling shaft 30 is provided at one end with a pivotal section 31 which is pivotally connected with an end portion 25 of the pulling shaft seat by a pivotal shaft 32. The pivotal section 31 has a pushing section 33 at the rear end which is formed with a slot 34 above the pushing section 33. The pulling shaft 30 has a hole 35 having an end in alignment with the sliding slot 24 of the polling shaft seat 20. The other end of the hole 35 extends through the pulling shaft 30 to form an opening 36. The wall of the hole 35 is provided with two scarring plates 37 and two positioning ribs 38.

The central portion of the positioning toothed block 40 is pivotally connected with the pulling shaft seat 20 by a pivotal shaft 41. The positioning toothed block 40 is provided at an end with a tooth 42 engageable with rise teeth 12 of the securing seat 10. The other end of the positioning toothed, block 40 has an interlinking section 43 extending into the opening 34 above the pushing section 33.

The resilient member 44 is mounted on the securing plate 26 of the pulling shall seat 20 and has an end bearing against the interlinking section 43 of the positioning toothed block 40 thereby forcing the tooth 42 of the positioning toothed block 40 to engage with the teeth 12 of the securing seat 10.

The interlinking block 45 is fitted in the sliding slot 24 and the hole 35 between pulling shaft seat 20 and the pulling shaft 30 and can slide an appropriate distance along the sliding slot 24 and the hole 35. The interlinking block 45 has an end provided with a cutting slot 46 in winch is fitted a pivotal shaft 47.

The pulling block 50 is has an end protruded out of the opening 36 of the pulling shaft 30 and the other end connected with a linking rod 51 which extends into the hole 35 and connected with the pivotal shaft 47 of the interlinking block 45.

The spring 52 is mounted on tire linking rod 51 of the polling block 50, and has an end urging against an end of the pulling block 50, and the other end fastened to the securing plate 37 mounted at the wail of the hole 35.

The shaft housing 53 is mounted on the pulling shaft seat 20 and the pulling shaft 30 to make it easier to be held by the user.

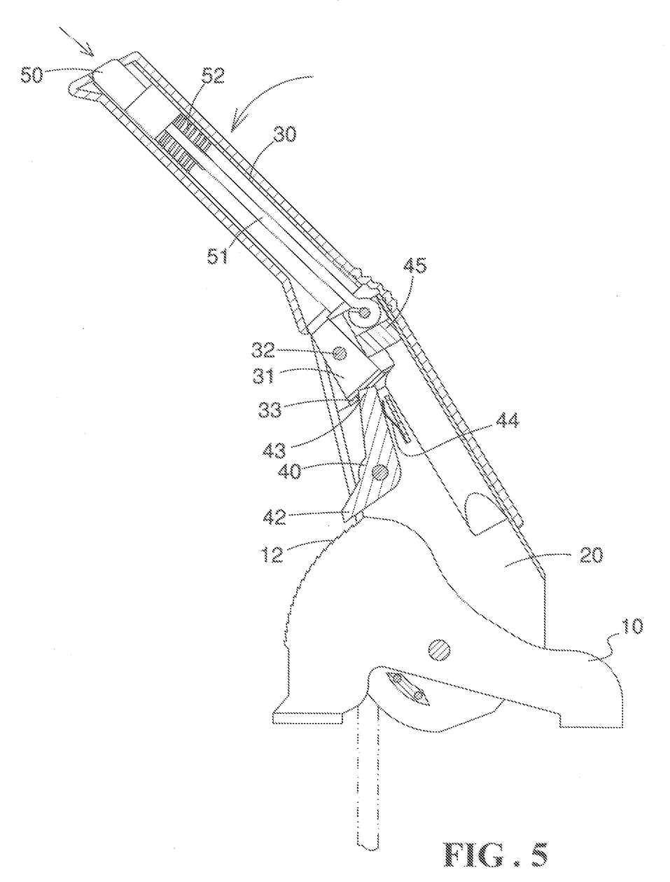

Referring to FIG. 5, when the pulling shaft 50 is depressed to compress the spring 52, the linking rod 51 will move the interlinking block 45. As the interlinking block 45 is moved to the connection between the pulling shaft 30 and the pulling shaft seat 20, the pulling shaft 30 will no longer be controlled by the interlinking block 45 and will be able to rotate downwardly with respect to the pivotal shaft 32. In the meantime, the pushing section 33 at tire rear end of the pivotal section 31 of the pulling shaft 30 forms a lever mechanism to push the interlinking section 43 of the positioning toothed block 40 thereby causing the positioning toothed block 40 to rotate an angle in clockwise direction and therefore engaging the tooth 42 of the positioning toothed block 40 with the teeth 12 of the securing seat 10 thereby achieving the positioning purpose and controlling the braking device.

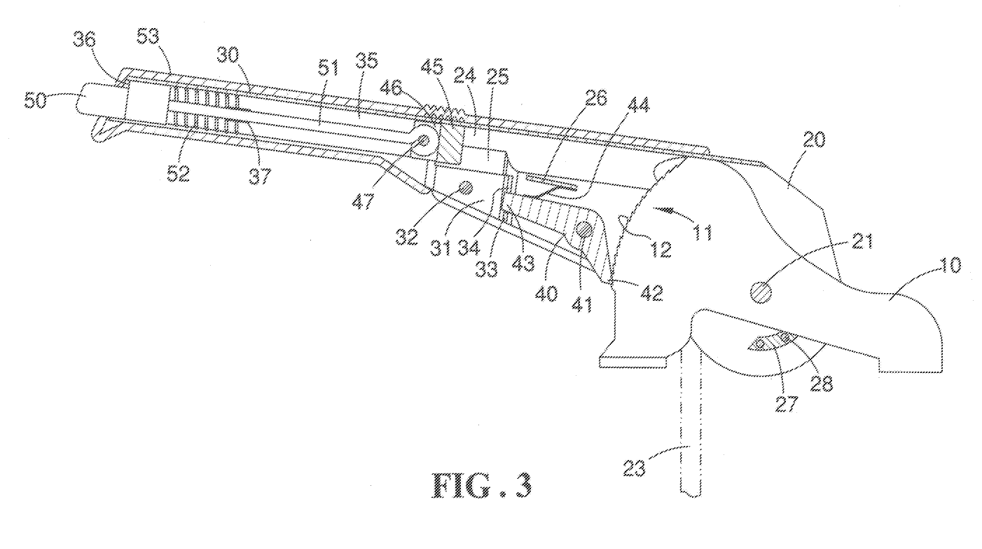

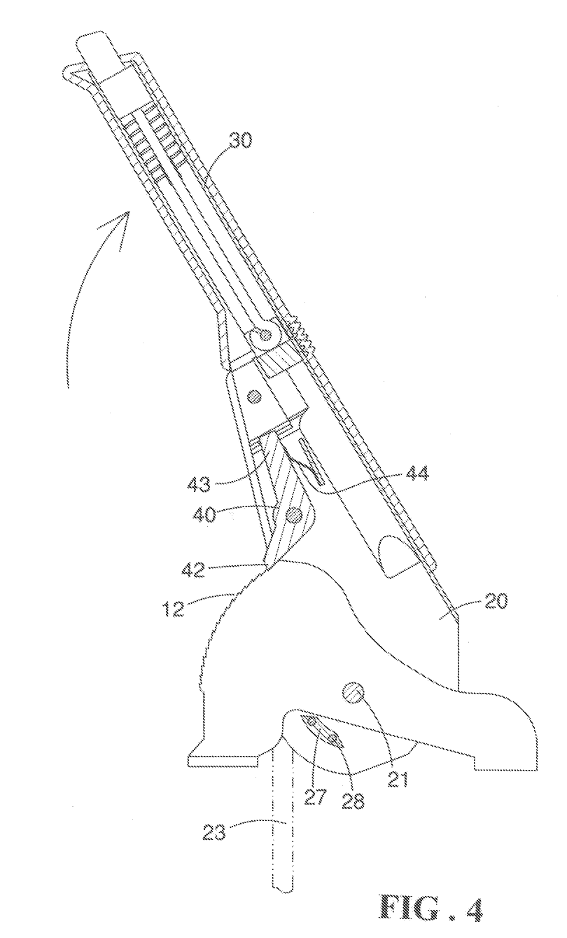

Referring to FIGS. 3 and 4, when the pulling shaft 30 is pulled upwardly the pulling shaft 30 will drive fee pulling shaft, seat 20 to move upwardly thereby causing the tooth 42 of the positioning toothed block 40 to slide from a tooth 12 to another tooth 12 of the securing seal 10. Meanwhile, the interlinking section 43 of the positioning toothed block 40 pushes against the resilient member 44. When the pulling shaft 30 is pulled upwardly to an appropriate position, the tooth 42 of the positioning toothed block 40 will be forced by the resilient member 44 to engage with the tooth 12 thereby achieving the positioning effect. Hence, the pulling shaft seat 20 can be pulled by the pulling shaft 30 upwardly to a fixed position thereby controlling the braking device via the braking cable 23.

It will be understood that each of the elements described, above, or two or 20 more together may also find a useful application in other types of methods differing from the type described above.

The hand brake structure according to the present invention utilizes a pulling shaft 30 to rotate with respect to an end of the pulling shaft seat 20 so as to make the pushing section 33 of the pulling shaft 30 to move the positioning toothed block 40 thereby disengaging the tooth 42 from the tooth 12. Hence, the hand brake according to the present invention can be easily operated, as desired and requires less labor power than the conventional.

While certain novel features of this invention, have been shown and described and are pointed, out ha the annexed claim, it is not intended to be limited to the details above, since it will be understood that various omissions, modifications, substitutions and changes in tire structure and details of the device illustrated and in its operation can be made by those skilled in the art without departing in any way from the spirit of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing hi any way from the spirit of the present invention.

I claim:

1. A hand-brake structure comprising:
a securing seat having a side edge provided with a plurality of teeth;
a pulling shaft scat pivotally connected with said securing seat by a pivotal shaft and provided with a guiding slot in which is surrounded a braking cable, said braking cable having a first end fastened to an end section of said guiding slot and a second, end connected to a braking device;
a pulling shaft having a pivotal section which is pivotally connected with said pulling shaft seat by a pivotal shaft, said pivotal section having a pushing section, said pulling shaft having a hole extending through said pulling shaft to form at) opening;
a positioning toothed block pivotally connected with said polling shaft seat by a pivotal shaft, said positioning toothed block, having a first end provided with a tooth engageable with said teeth of said securing seat and a second end provided with an interlinking section extending over said pushing section;
a resilient member having a first end fixed on said pulling shaft seat and a second end bearing against said interlinking section of said positioning toothed, block thereby forcing said, tooth of said positioning toothed block to engage with said teeth of said securing seat;
an interlinking block, fitted in said sliding slot and said hole and capable of moving in said sliding slot and said hole;
a pulling block, having a first end protruded out of said opening of said pulling shaft and a second end connected with a linking rod which is connected with an end of said interlinking block; and
a spring mounted on said linking rod of said pulling block and having a first end urging against an end of said pulling block and a second end fastened to a wall of said hole.

2. The hand-brake structure as claimed in claim 1, wherein one lateral edge of said securing seat is formed with a circular arch and said teeth are positioned on said circular arch.

3. The hand-brake structure as claimed in claim 1, wherein said pulling shaft seat has an end sat section pivotally connected with said pivotal section of said pulling shaft.

4. The hand-brake structure as claimed in claim 1, wherein said pulling shall seat has a securing plate, and said resilient member has an end fixedly mounted on said securing plate.

5. The hand-brake structure as claimed in claim 1, wherein, a stopping block is fixedly mounted on said pulling shaft seat and bears against said securing seat thereby limiting swinging angle of said pulling shaft seat.

6. The hand-brake structure as claimed in claim 1, wherein said interlinking block is provided with a cutting slot in which is fitted a pivotal shaft, and one end of said linking shaft is pivotally mounted to the pivotal shaft of said interlinking block.

7. The hand-brake structure as claimed in claim 1, wherein said hole of said pulling shaft has a wall provided with two searing plates and positioning ribs, and said spring has an end fixed on said securing plates of said pulling shaft.

8. The hand-brake structure as claimed in claim 1, wherein an exterior of said pulling shaft and said pulling shaft seat are covered with a shaft housing.
